(19) United States
(12) Patent Application Publication
(10) Pub. No.: US 2007/0169021 A1
(43) Pub. Date: Jul. 19, 2007

(54) Report Generation System

(75) Inventors: Sunny Huynh, Phoenixville, PA (US); Haiwen Zhu, West Chester, PA (US)

Correspondence Address: SIEMENS CORPORATION;INTELLECTUAL PROPERTY DEPARTMENT, 170 WOOD AVENUE SOUTH, ISELIN, NJ, 08830, US

(73) Assignee: Siemens Medical Solutions Health Services Corporation, Malvern, PA (US)

(21) Appl. No.: 11/555,403

(22) Filed: Nov. 1, 2006

Related U.S. Application Data
(60) Provisional application No. 60/735,018, filed on Nov. 10, 2005.
(60) Provisional application No. 60/732,018, filed on Nov. 1, 2005.

(51) Int. Cl. G06F 9/45; G06F 9/44

(52) U.S. Cl. 717/136; 717/114

(57) ABSTRACT

A report generation system includes a first transformation processor for processing individual coded template text representative phrases for accommodating corresponding data items to provide corresponding formatted individual phrases. The individual coded template text representative phrases are associated with corresponding individual conditional logic statements. A second transformation processor processes received data items and the formatted individual phrases to incorporate the data items into corresponding formatted individual phrases to provide formatted report text. The second transformation processor also uses the corresponding individual conditional logic statements to determine whether an individual phrase is included in the formatted report text.

This application derives priority from Provisional Patent Application Ser. No. 60/735,018, filed on Nov. 1, 2005.

### FIELD OF THE INVENTION

The present invention relates generally to the field of data processing, and more specifically to a report generation and word processing system.

### BACKGROUND OF THE INVENTION

In the practice of medicine the need frequently arises for narrative reports and related text. Unfortunately, most medical personnel do not have sufficient time to properly compose all of the required individual reports. Numerous attempts have been made to address this problem by creating some type of automated or simplified report generator. Existing report generators can be grouped into several different categories commonly known as grammar based, knowledge based or template based.

Grammar based reporting systems permit the generation of very complex and flexible reports. The report created by grammar based systems appears as if it has been dictated and transcribed due to the extensive use of grammatical rules. Most grammar based reporting systems rely on the use of context free grammars to express their grammatical rules. Unfortunately most natural languages cannot be fully expressed by using context free grammar. In order to overcome this deficiency, grammar based systems must support a myriad of syntax rules requiring a substantial amount of preparation and setup. Customization, maintenance, and usage of these systems are highly complicated by the tremendous number of rules. Internationalization and translation is accomplished through the rewriting of vast numbers of rules. Due to these disadvantages, grammar based reporting systems are not suitable for general medical reporting.

Knowledge based report generation systems define sentence fragments that are derived from database elements which are then strung together to form complete sentences. Knowledge based reporting systems are either generally not customizable or are difficult to customize. Modification of the various sentence fragments can only be performed with caution in order to ensure the maintenance of grammatical correctness in each sentence. The nature of knowledge based systems typically prohibits user specification of which sentences or sentence fragments are to be displayed based on database element values. The show or hide sentence logic is rigidly controlled by whether the database elements are valued.

Template based reporting systems are similar to existing mail merging programs in which place holders for database elements are populated with the database values. Existing template systems represent hierarchical/repetitive (H/R) data by repeating a template sentence. Each time the sentence is repeated, the next set of values for the database elements in the H/R structure is inserted into the template. Existing template based systems represent H/R data as repeating sentences that seem artificial and which also consume substantial screen and print area.

A system constructed according to the principles of the present invention addresses the foregoing deficiencies and their related solutions.

### BRIEF SUMMARY OF THE INVENTION

In accordance with principles of the present invention, a report generation system includes a first transformation processor for processing individual coded template text representative phrases for accommodating corresponding data items to provide corresponding formatted individual phrases. The individual coded template text representative phrases are associated with corresponding individual conditional logic statements. A second transformation processor processes received data items and the formatted individual phrases to incorporate the data items into corresponding formatted individual phrases to provide formatted report text. The second transformation processor uses the corresponding individual conditional logic statements to determine whether an individual phrase is included in the formatted report text.

### BRIEF DESCRIPTION OF THE DRAWING

In the drawing:

FIG. 1 is block diagram illustrating a report generation system according to the principles of the present invention;

FIGS. 2A and 2B together illustrate an extended markup language (XML) program listing of a first example of a phrase template utilized by the report generation system illustrated in FIG. 1 according to principles of the present invention;

FIG. 3 illustrates a portion of an XML program depicting a repeatable natural language generator list as utilized by a phrase template as depicted, for example, in FIGS. 2A and 2B according to principles of the present invention;

FIG. 4 illustrates a flow chart illustrating the workflow of the system depicted in FIG. 1 according to principles of the present invention;

FIG. 5 illustrates a flow chart showing the generated report editing function utilized by the system depicted in FIG. 1 according to principles of the present invention;

FIG. 6 illustrates a flow chart illustrating the generated report formatting function utilized by the system depicted in FIG. 1 according to principles of the present invention;

FIG. 7 illustrates an example of a graphical user interface utilized by the system depicted in FIG. 1 according to principles of the present invention;

FIGS. 8A and 8B together illustrate an extended markup language (XML) program listing of a second example of a phrase template utilized by the report generation system depicted in FIG. 1 according to principles of the present invention;

FIGS. 9A and 9B together illustrate a depiction of the intermediate result produced by transformation of a first phrase appearing in FIG. 8 according to principles of the present invention;

FIGS. 10A, 10B and 10C together illustrate a depiction of the intermediate result produced by transformation of a second phrase appearing in FIG. 8 according to principles of the present invention; and

FIGS. 11A, 11B and 10C together illustrate a depiction of the intermediate result produced by transformation of a third phrase appearing in FIG. 8 according to principles of the present invention.

### DETAILED DESCRIPTION OF THE INVENTION

A processor, as used herein, operates under the control of an executable application to (a) receive information from an input information device, (b) process the information by manipulating, analyzing, modifying, converting and/or transmitting the information, and/or (c) route the information to an output information device. A processor may use, or comprise the capabilities of, a controller or microprocessor, for example. The processor may operate with a display processor or generator. A display processor or generator is a known element for generating signals representing display images or portions thereof. A processor and a display processor comprises any combination of, hardware, firmware, and/or software.

An executable application, as used herein, comprises code or machine readable instructions for conditioning the processor to implement predetermined functions, such as those of an operating system, a report generation system or other information processing system, for example, in response to user command or input. An executable procedure is a segment of code or machine readable instruction, sub-routine, or other distinct section of code or portion of an executable application for performing one or more particular processes. These processes may include receiving input data and/or parameters, performing operations on received input data and/or performing functions in response to received input parameters, and providing resulting output data and/or parameters.

A user interface (UI), as used herein, comprises one or more display images, generated by the display processor under the control of the processor. The UI also includes an executable procedure or executable application. The executable procedure or executable application conditions the display processor to generate signals representing the UI display images. These signals are supplied to a display device which displays the image for viewing by the user. The executable procedure or executable application further receives signals from user input devices, such as a keyboard, mouse, light pen, touch screen or any other means allowing a user to provide data to the processor. The processor, under control of the executable procedure or executable application manipulates the UI display images in response to the signals received from the input devices. In this way, the user interacts with the display image using the input devices, enabling user interaction with the processor or other device. A graphical user interface (GUI) comprises one or more graphical display images enabling a user to interact with a processor or other device.

A phrase template, as used herein, is the definitional template of narrative text, database element placeholders, NLG (natural language generation) List, and conditional logic. A report generator uses it in creating a generated phrase. A phrase is a general term that can correspond to a sentence fragment, sentence, or multiple sentences. A generated phrase is the grammatically correct narrative text produced by a report generator corresponding to a phrase template. Conditional logic is user-defined logic that is evaluated by the report generator and determines whether a phrase should be shown in the generated document. The concept of a natural language generation (NLG) list allows for the creation of sets of data and text, in which the report generator automatically handles placement of commas and conjunctions, i.e. “and” and/or “or”.

In general, a report, and in particular a formatted natural language medical report from clinical data, may be generated in the following manner, according to principles of the present invention. A template of natural language phrases that are likely to appear in the medical report is created. The clinical data is processed so as to insert selected data into predetermined locations within the template. An evaluation of the presence and/or absence of clinical data in each of the predetermined locations within the template is conducted. A natural language medical report is formatted in response to the evaluation of data populating the predetermined locations within the template.

More specifically, an image representing editable individual phrases derived from the template and the evaluation of the presence and/or absence of clinical data, is displayed via a graphical user interface accessible to a user of the clinical data so as to permit editing of the individual phrases. The user is alerted to the absence of required data within the editable individual phrases, and to the absence of an editable individual phrase from displayed editable individual phrases whenever an absent phrase has been associated with an existing clinical data value.

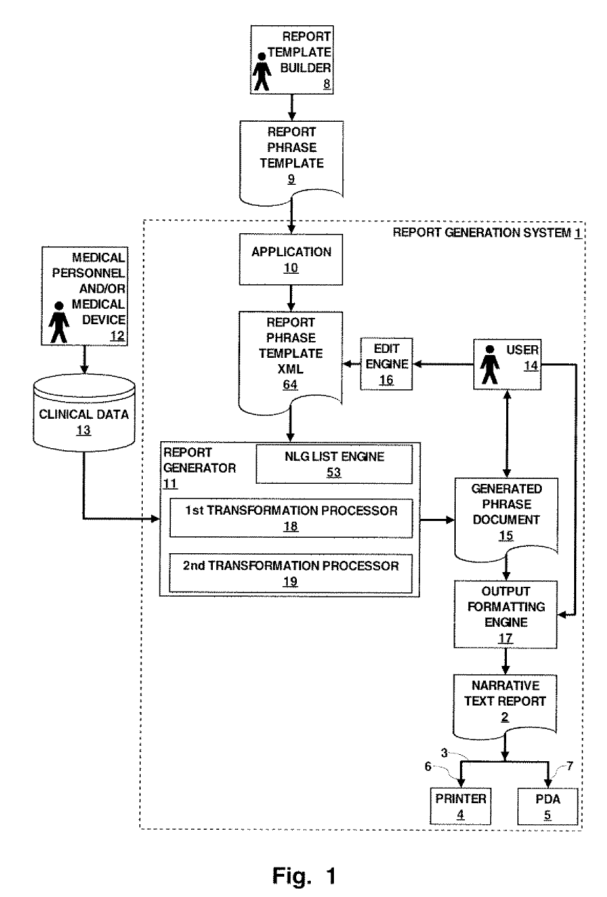

Referring to FIG. 1, a report generation system 1 is illustrated. The system 1 creates a narrative text report 2 which may be transferred to a network 3, enabling transfer of the report 2 to various destinations such as a printer 4 or a personal digital assistant (PDA) 5. The text in the text report 2 may be formatted in an adaptively selectable output format such as: (a) DHTML, (b) HTML, (c) PDF, (d) RTF, (e) Word, (f) LaTeX, (g) SVG, and/or (h) other similar output format. The interconnections 6 and 7 between the network 3 and the printer 4 and PDA 5 may be cable, telephone line, wireless communications link and/or any other form of data communication link. The generated report 2 may be inserted into or interfaced with many medical applications and/or non-narrative reporting tools including web based or rich text clients. In a preferred embodiment, the report 2 pertains to medical data gathered and evaluated with reference to a particular patient.

Before the report 2 can be generated, a person 8 identified as the report template builder defines and constructs a report phrase template 9. The report phrase template 9 includes data representing: a collection of narrative text, placeholders for accommodating corresponding data, a natural language generator (NLG) list, and conditional logic. The builder 8 may use either a graphical user interface (GUI) in defining the template 9 or create the template manually in those situations in which the template structure is relatively simple. Once the report template 9 has been created the template 9 is forwarded to an executable application 10 which transforms the template 9 into an XML template 64.

Medical personnel and/or medical devices 12 generate clinical data 13 through patient examinations, lab reports, etc. which ultimately becomes the substantive content of the report 2. When the system 1 is invoked, the report phrase template 9 supplies via units 10,64 individual coded template text representative phrases to a report generator 11 which builds grammatically correct phrases and/or sentences. The clinical data 13 operates as a source of data items adapted to be inserted into predetermined locations, marked by placeholders, within the individual coded template text representative phrases. The report generator 11 merges the clinical data 13 with the data derived via units 10,64 from the report phrase template 9 and applies conditional logic to select phrases from the available text representative phrases. Conditional logic is used to select particular phrases from those that are available in the report phrase template 9 based on each database element value.

The report generator 11 contains first and second XSL transformation processors 18 and 19 that use data from the XML report template 64 and clinical data 13 as inputs to generate a user interactive collection of generated phrases in a generated phrase document 15. The phrase document 15 may be edited by the user 14 in generating the final narrative text report 2.

The first transformation processor 18 processes individual coded template text representative phrases from the XML report phrase template 64 for accommodating corresponding data items that may be contained within the clinical data 13 to provide corresponding formatted individual phrases. The individual coded template text representative phrases are associated with corresponding individual conditional logic statements. The individual conditional logic statements are user defined logic evaluated by the report generator 11 to determine whether an individual phrase should be utilized in the narrative text report 2.

The second transformation processor 19 processes received data items from the clinical data 13, and the formatted individual phrases from the first transformation processor 18 to incorporate the data items into corresponding formatted individual phrases to provide formatted report text. The received data items are, for example, clinical data items concerning a particular patient. In this case, the formatted report text includes text for inclusion in a medical report concerning the particular patient.

More specifically, in the illustrated embodiment, the second transformation processor 19 processes the received data items and formatted individual phrases to incorporate the data items into the placeholders in corresponding individual coded template text representative phrases. In addition, the second transformation processor processes the received data items and the formatted individual phrases to incorporate the data items in corresponding formatted individual phrases to provide formatted report text in an adaptively selectable output format (e.g. PDF, RTF, etc.), as described in more detail above. The second transformation processor 19 also uses the corresponding individual conditional logic statements associated with the individual coded template test represented phrases to determine whether an individual phrases is included in the formatted report text.

The formatted report text is grammatically correct narrative text produced by the report generator 11 in response to data from the report phrase template 9 and clinical data 13. NLG list data contained within the report phrase template 9 permits the report generator 11 to identify sets of data and text. The NLG list engine 53, within the report generator 11, automatically generates natural language list phrases by, e.g. placing commas and conjunctions in lists and/or performing other similar functions, in response to the identified sets of data and text.

The formatted generated phrase document 15 produced by the second transformation processor 19 is then presented for editing to the user 14 via a display processor (not shown). The user 14 is able to modify to the phrases in the phrase document 15 using the edit engine 16. The edit engine 16 modifies the data in the report phrase template XML 64 according to user 14 input. The report generator 11, in turn, generates a phrase document 15 revised according to the user 14 input, which is displayed for the user 14 for editing. When the user 14 is satisfied with the content of the selected phrases in the phrase document 15, the user 14 may invoke the output formatting engine 17 to convert the phrases into a desired output document format, described above, to be displayed on the screen of the PDA 5, printed via printer 4 or otherwise transmitted via the network 3.

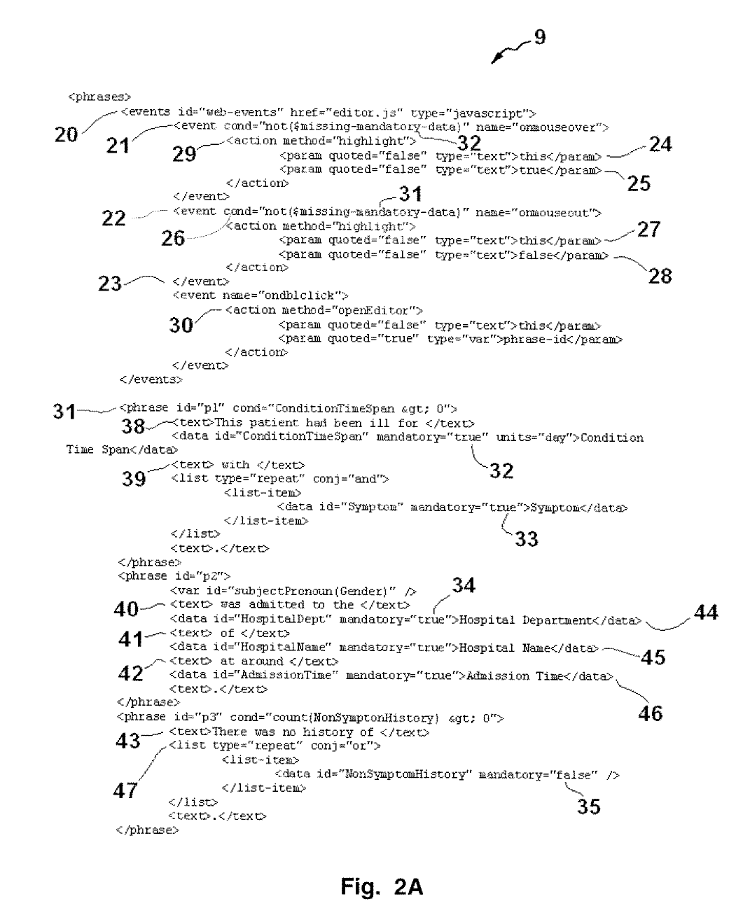

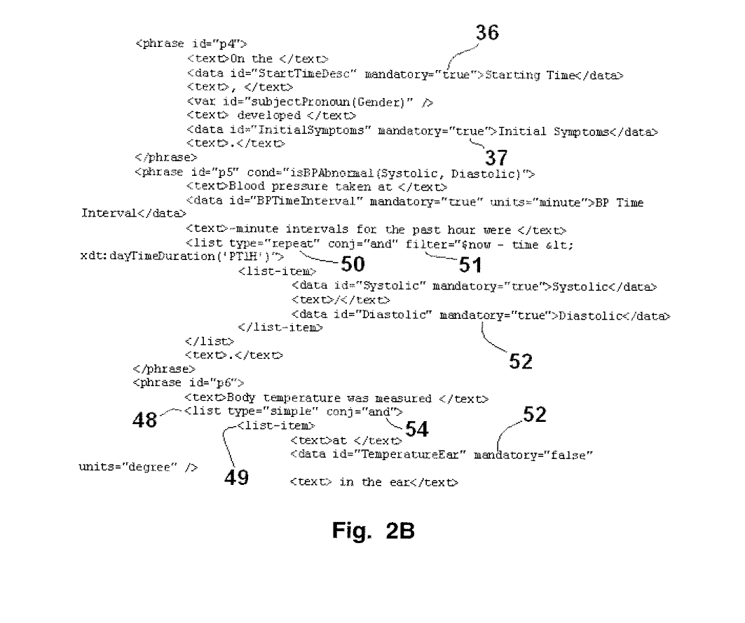

In general, a first computer readable language is used for coding the individual template text representative phrases in the report phrases template 9. An example of a report phrase template 9, written in extended markup language (XML), is shown in FIGS. 2A and B. That is, the individual coded template text representative phrases in the report phrase template 9 are defined by XML coded template text. The report phrase template 9 in the illustrated embodiment defines events and phrases.

In the report phrases template 9, the <events> tag 20 defines data representing respective customizable events 21, 22 and 23. The respective customizable events 21, 22, 23 have conditions associated with them (e.g. event condition 26). During the operation of report generator 11, the event conditions are evaluated based on the data values present for each phrase to determine whether to attach the corresponding event handlers (e.g. 24, 25 and 27, 28) to a generated phrase. When an event handler is attached to a corresponding phrase, the resulting phrase is configured to be user interactive. For example, if the events 21 and 22 are attached to a phrase, the phrase can be highlighted (lines 29) when the cursor controlled by a mouse passes over the phrase (lines 24 and 25) and un-highlighted when the cursor moves away from the phrase (lines 27 and 28). Similarly, if the event 23 is attached to a phrase, the edit engine 16 (FIG. 1) can be invoked (line 30) when the user double-clicks the mouse.

A ‘mandatory’ data element refers to a particular database element that is required for proper phrase completion. A database element may be specified as ‘not mandatory’ for data entry or other business logic not related to the proper generation of phrases. Referring to FIG. 1, when the builder 8 marks certain data elements as mandatory, and that particular element is not valued, then the resulting phrase will not be grammatically correct, and the user 14 is prompted to correct the mistake appearing on the generated phrase document 15. If a data element is not mandatory then an unvalued data element will not be shown in a phrase. If none of the data elements in a phrase are mandatory, then no part of the phrase will appear when all of the data elements are unvalued.

The rest of the report phrases template 9 contains definitions of phrases. A <phrase> tag (e.g. 31) delineates the definition of the phrase and permits the optional specification of data place holders and associated conditional logic, such as for example conditional logic parameters 32, 33, 34, 35, 36 and 37. The conditional logic is evaluated, based on the assigned data values, by the report generator 11 in order to determine whether a phrase should be included or not included.

The <text> tags 38, 39, 40, 41, 42, 43 identify the narrative text portion of a phrase. For example, text tag 38 identifies the text “This patient had been ill for”, text tag 39 identifies the word “with”, text tag 40 identifies the text “was admitted to the”, text tag 41 identifies the word “of”, tag 42 identifies the words “at around” and tag 43 identifies the text “There was no history of”. The <data> tags 44, 45, 46, represent database element placeholders. The report generator 11 replaces the data placeholders with the actual data values from the clinical database 13 in order to generate the completed phrases. For example, the <data> tag 44, identified as “HospitalDept” is replaced by the clinical data representing the data “Hospital Department”, which in the illustrated embodiment has the value “Emergency Department”. The other <data> tags, 45, 46, are processed in the same manner.

The <list> tags (e.g. 47) contain data representing an NLG list. The data displayed in such lists represent sets of related data in the clinical database 13 (FIG. 1). Such a list may include data representing simple (or flat) data lists, and/or hierarchical/repetitive data lists, described in more detail below. The sets of data represented by the <list> tags are replaced by a textual list including the associated set of clinical data. In the illustrated embodiment, for example, the <list> tag 47, represents a repetitive data list drawing data from the associated set of data values identified as “NonSymptomHistory” in the clinical database 13. In the illustrated embodiment, the “NonSymptomHistory” data derived from database 13 includes three values: “fever”, “rash” and “gastrointestinal symptomatology”. The conjunction to be used before the last data item is “or” as specified in the <list> tag. Consequently, the list tag is replaced by the NLG list starting with the text represented by the text tag 43 (described above) followed by respective list items corresponding to the set of clinical data values: “There was no history of fever, rash, or gastrointestinal symptomatology”. The other <list> tags are processed in a similar manner, described in more detail below.

After processing a particular report template 9 with a set of associated clinical data 13, the medical report generator 11 creates, for example, the following text:
This patient had been ill for 2 days with coughing and headache. She was admitted to the Emergency Department of XYZ Hospital at around 4:00 PM. There was no history of fever, rash, or gastrointestinal symptomatology. On the evening of September 10, she developed mild pain, dizziness, and fever. Blood pressure taken at 15-minute intervals for the past hour were 151/91, 137/91, 120/82, and 113/76. Body temperature was measured at 102.7 degrees in the ear and 103.1 degrees under arm.

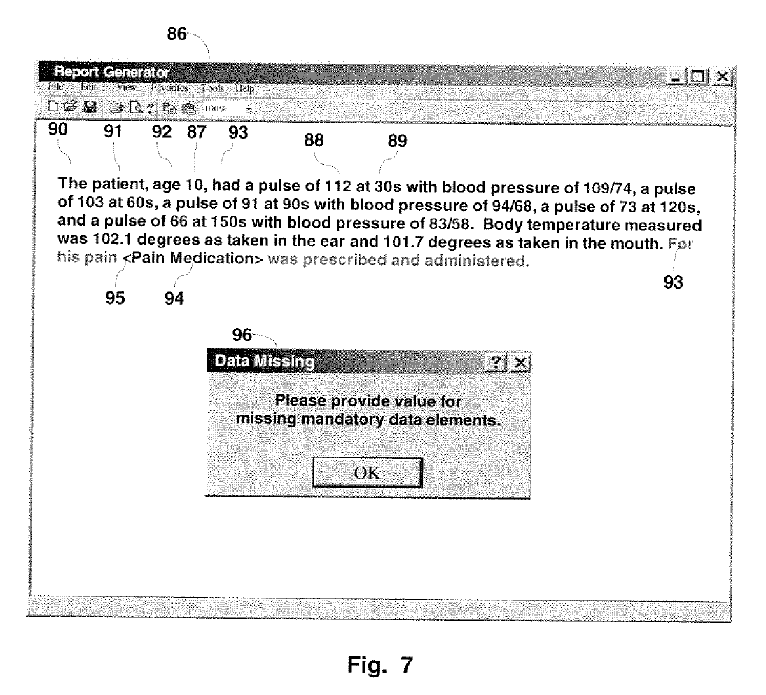

FIG. 7 depicts a graphical user interface 86 that permits editing of the generated document 15 by the user 14 (FIG. 1). The mandatory database elements having values, e.g. 87, 88 and 89, are displayed. In an alternate embodiment, these database elements may be displayed in a first contrasting color to distinguish them from the narrative text elements 90, 91, 92 and 93, for example, thereby simplifying the editing task. In the event that a mandatory database element has not been entered, a prompt window 96 appears within user interface 86. The entire sentence 93 may be highlighted in a second contrasting color to alert the user 14 to the location of the sentence lacking the mandatory data element 94. The missing database element 94 may be surrounded by angle brackets 95 as a further prompt to the user 14. In another embodiment, the missing data element 94 may be highlighted in another contrasting color to alert the user 14. The contrasting colors, described above may further be implemented as different shades of gray.

The present system 1 (FIG. 1) supports simple, and/or repeatable natural language generation (NLG) lists which may be used to generate text representing simple (or flat) data, and/or hierarchical/repetitive data, respectively. Data, and in particular clinical data 13, is represented in an NLG list format which produces natural sounding sentences. A simple NLG list 48 and a repeatable NLG list using a repetitive data model are shown in the sample report phrase template 9 (FIGS. 2A and 2B). A simple NLG list 48 (FIG. 2B) is used to represent flat, non-hierarchical data. Each list item 49 in a simple NLG list is evaluated and displayed in a comma separated list. List items may contain text and data, and can be conditionally displayed or hidden based on user defined logic. The last data item is separated from the list by a specified conjunction 54.

A repeatable NLG list 50 is seen to complement the simple NLG list 48 by allowing the user 14 to display respective sets of hierarchical or repetitive data. The list permits the incorporation of data items 13 in a list without repeating a particular individual phrase for each received data item. The user 14 can specify a data filter 51 when using the repeatable NLG list 50. If the data 13 is hierarchical, then the filter 51 specifies the hierarchy or path to the desired data. If the data 13 is repetitive, then the filter 51 specifies the desired set of records. Unlike the simple NLG list 48, list items in the repeatable NLG list 50 are not separated by commas. The list item in the repeatable NLG list 50 allows the user 14 to configure conditional logic in order to hide part of a sentence. Each record of the retrieved data is processed through the list items, and separated by commas.

Similarities exist between the simple NLG list 48 and the repeatable NLG list 50. List items in both types of list may contain both textual and data elements. Within a list item, the builder 8 can mark certain data elements 52 as mandatory. Both types of lists 48, 50 display comma separated information. The NLG list engine 53 ensures that a preconfigured conjunction 54, such as “and”, is inserted at a grammatically correct location.

Upon evaluation of each list item, the NLG list engine 53 determines if any of the data elements are valued. If none of the data elements are valued, then the list item as well as its accompanying comma is not displayed. List items with mandatory data elements 52 are always displayed. If a mandatory data element 52 is not valued, then a user interface indicator prompts the user to insert the missing data value, as illustrated in FIG. 7. The user 14 may also specify conditional logic under which a list item is shown or hidden.

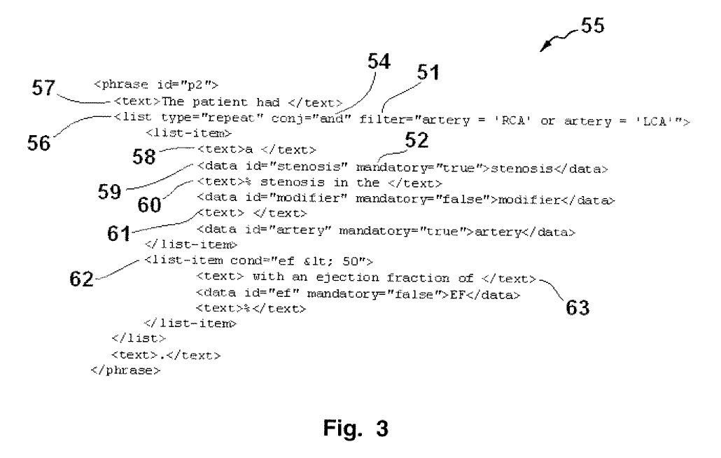

FIG. 3 depicts a separate portion 55 of a report phrase template illustrating a repeatable NLG list 56 using a hierarchical data model. The template 55 begins with the text tag 57 “The patient had”. Text tag 58, within the list tag 56, inserts the word “a”. Data tag 59 indicates 52 a mandatory field, having the identifier “stenosis” and representing, in this case, a percentage of stenosis, which for example might be 90%. Text tag 60 describes the data represented by the data tag 59 using the text “% stenosis in the”. The text tag 61 does not insert text, but permits the insertion of text relating to the stenosis measurement by the user when the completed phrase is reviewed by the user, as described above. For example, the stenosis measurement might pertain to the “MID RCA” (right coronary artery). A second stenosis measurement might be made in the proximal LCA (left coronary artery) which might have a value, for example, of 78%. List item tag 62 shows text and data tags for including an ejection fraction (ef) description. The condition associated with the list item tag 62 specifies that the ef must have a value of less than 50% in order to be included in the generated text.

Thus if the ejection fraction associated with the MID RCA stenosis measurement in the clinical data 13 is for example 60%, the text 63 relating to the ejection fraction will be hidden, while an ejection fraction value, for example, of 30% associated with the proximal LCA will be shown in the report text. Given the foregoing exemplary data, the generated repeatable NLG list text is:
The patient had a 90% stenosis in the MID RCA and a 78% stenosis in the proximal LCA with an ejection fraction of 30%.

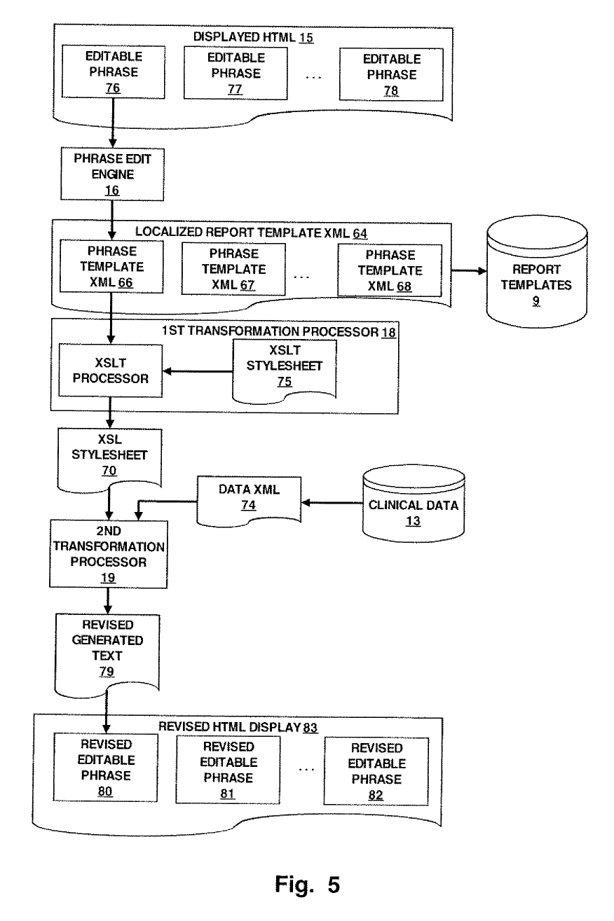

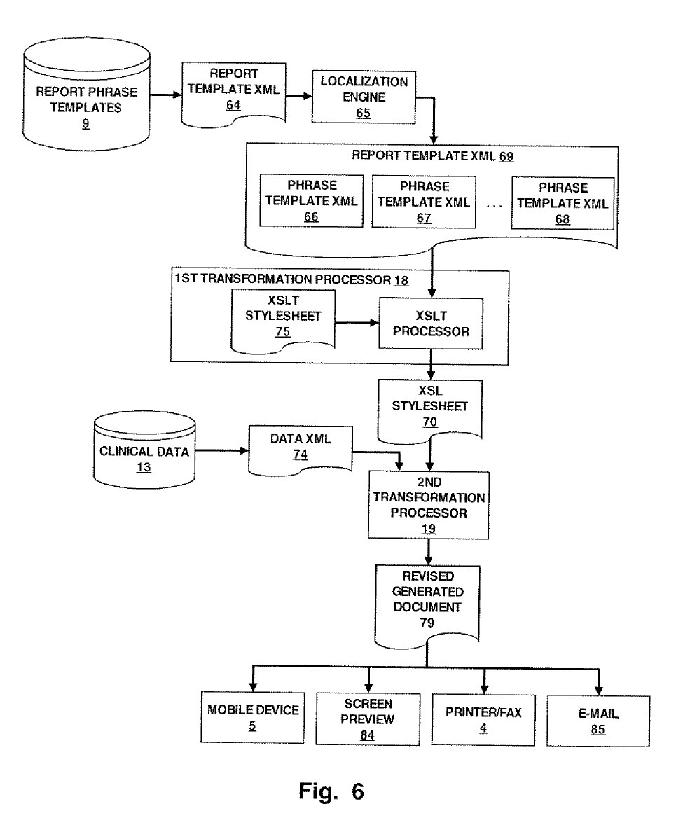

The mechanism by which the report generator 11 (FIG. 1) creates a generated phrase document 15 which may then be edited and distributed by the user 14 is more fully understood by referring to FIGS. 5 and 6. A first computer readable language is used for coding individual template text representative phrases, as described above. More specifically, in the illustrated embodiment, the report templates 9 are converted into an XML formatted templates 64 by application 10 (FIG. 1) as described above. Referring to FIG. 6, a localization engine 65 creates a localized XML report template 69 by separating the template 64 into individual XML phrase templates 66, 67 and 68, for example.

The core of the report generator 11 is the phrase generation logic. A second computer readable language is used for formatting individual phrases to create the formatted report text. More specifically, in the illustrated embodiment, The phrase generation logic utilizes extensible stylesheet logic (XSL). XSL complements XML by providing a method for formatting content written in XML. The report generator 11 (FIG. 1) design consists of two XSL transformations. A first transformation processor 18 creates an output data stream constructed in a second computer readable language. That is, the input to the first transformation processor 18 is the localized report XML template 69, as read from the original report template 64, and the first transformation processor 18 provides corresponding formatted individual phrases as XSL compatible data. The localized report XML template 69, is transformed by means of a predefined extensible stylesheet logic transformation (XSLT) file 75. The intermediate result produced by first transformation processor 18 is an XSL stylesheet file 70 containing a series of formatted individual phrases that include placeholders for data element values to be displayed in the final generated phrase.

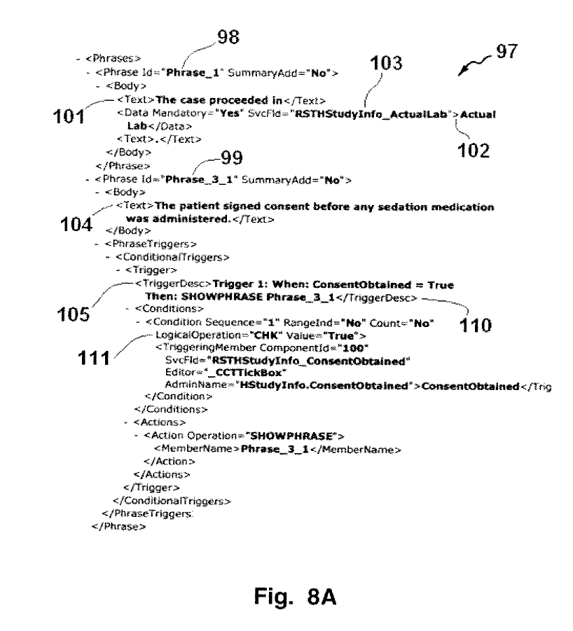

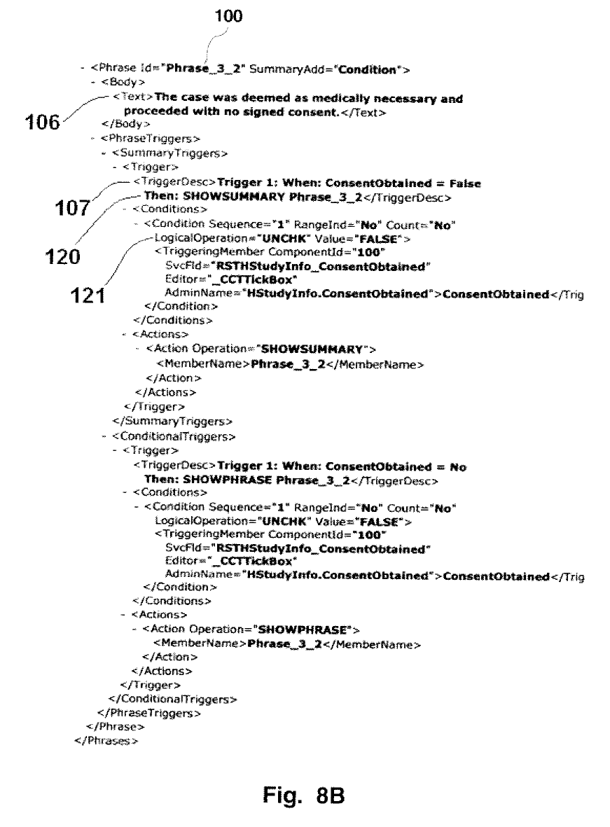

One skilled in the art understands that the use of XML for the phrase templates, XSLT style sheets for phrase transformation and XLS style sheets for formatted individual phrases, and associated transformation processes, is one of multiple schemas for representing such data and providing the transformations of that data. Any of the available schemas may be adapted to be used in a system according to the present invention. The selection of one of the available schema is dependent upon the specific application. FIGS. 8A, 8B, 9A, 9B, 9C, 10A, 10B, 10C, and 11A, 11B and 11C illustrate one concrete embodiment of such an application.

Referring to FIGS. 8A, 8B, 9A, 9B, 9C, 10A, 10B, 10C, and 11A, 11B and 11C, the operation of the first transformation processor 18 can be more fully understood. FIGS. 8A and 8B depict a sample phrase template 97 that contains definitions for three phrases 98, 99 and 100. The first phrase 98 contains a text tag 101 representing the text: “The case proceeded in”. A bracket 102, included in a data tag, is followed by the words “actual lab” which serve as a placeholder for the value of a clinical data 13 element 103 identified as “RSTHStudyInfo_ActualLab”. The second phrase 99 contains a text tag 104 representing the text: “The patient signed consent before any sedation medication was administered.” In order for the text represented by text tag 104 to be displayed in the editable document 15, the trigger condition 105, namely the fact that consent has been obtained is true, must be satisfied. The third phrase 100 contains the text tag 106 representing the text: “The case was deemed as medically necessary and proceeded with no signed consent.” In order for the text 106 to be displayed in the editable document 15 the trigger condition 107, that consent has been obtained is false, must be satisfied.

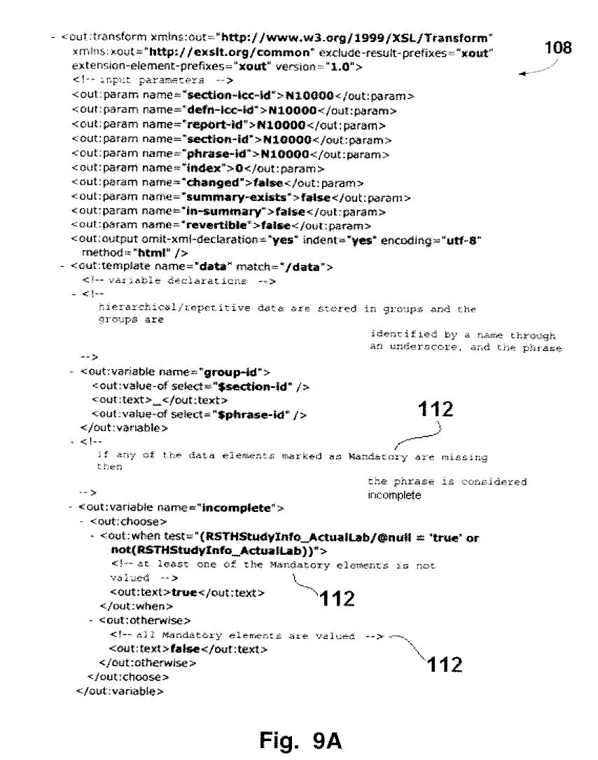

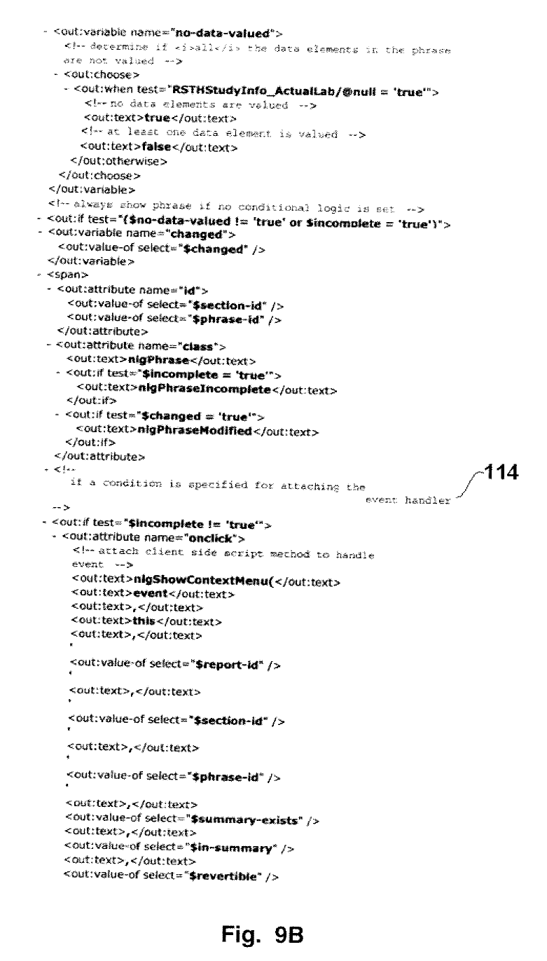

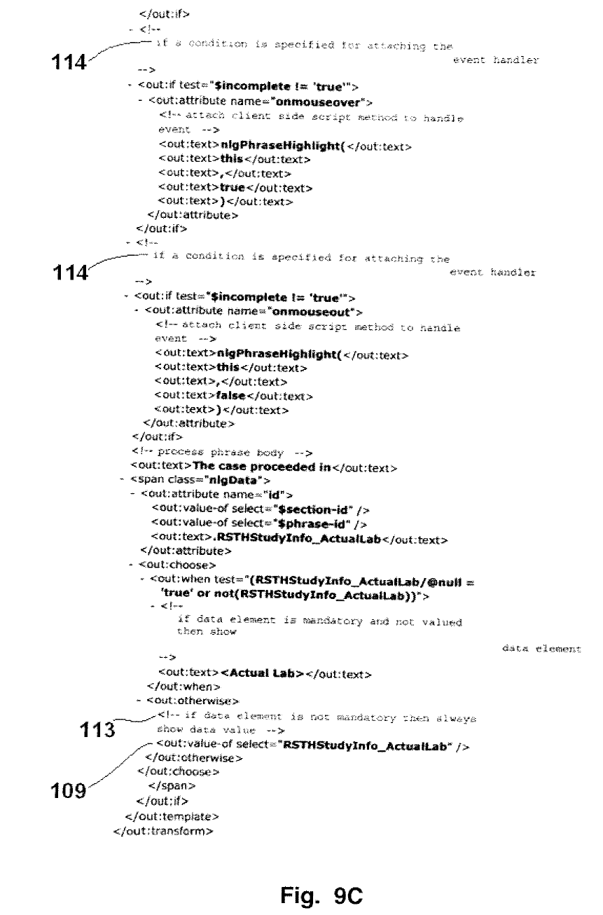

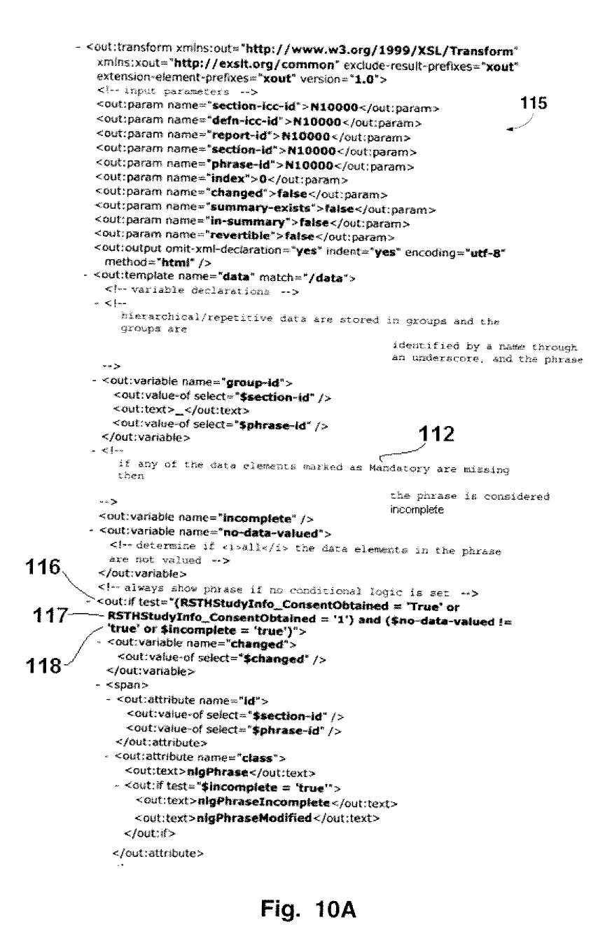

FIGS. 9A, 9B and 9C illustrate an output file 108 associated with the transformation of the first phrase 98 in FIG. 8. The file 108 is illustrated for explanation purposes and is not normally actually generated and/or saved in the form of a file during normal operation of the system 1. The first transformation processor 18 (FIG. 1) produces data representing an XSL file 108 including data associated with the phrase rendering logic such as mandatory data 112 (FIG. 9A), non-mandatory data 113 (FIG. 9C) and the attachment of customizable event handlers 114 (FIGS. 9B and 9C) according to the definition of phrase 98. Line 109 (FIG. 9C) of the output file 108, which reads “<out:value-of select=“RSTHStudyInfo_ActualLab” />”, is the location in the file 108 corresponding to the location of the placeholder where the data value 103 corresponding to RSTHStudyInfo_ActualLab is inserted.

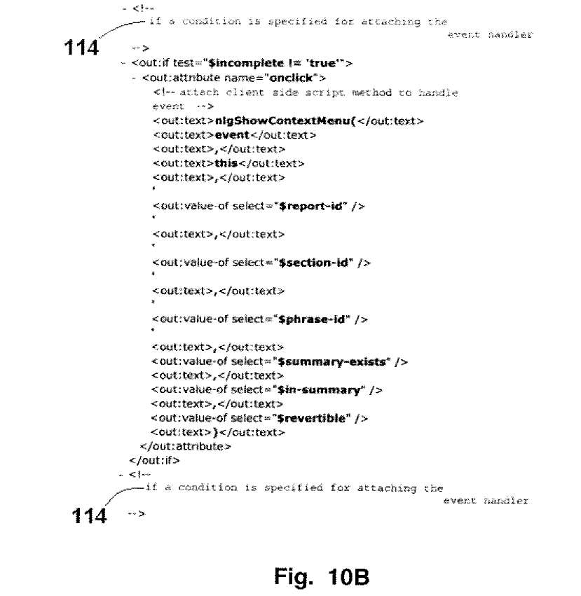

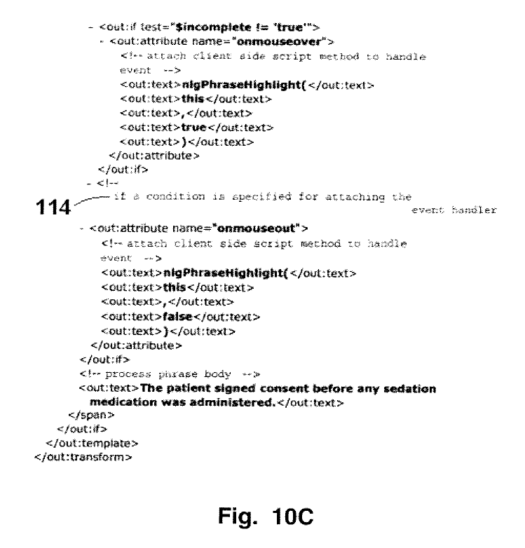

FIGS. 10A, 10B and 10C illustrate an output file 115 associated with the transformation of the second phrase 99. Referring back to FIG. 8, the first transformation processor 18 produces data in an XSL file 115 associated with the conditional logic 111 (FIG. 8A) of the show phrase segment 110 (FIG. 8A), which specifies that the text 104 be shown in the editable document 15 when the condition 111 (FIG. 8A) is satisfied. The XSL file 115 also associates other phrase rendering logic such as mandatory data 112 (FIG. 10A) and the attachment of customizable event handlers 114 (FIGS. 10B and 10C) according to the definition of phrase 99 (FIG. 8A). For example, the lines 116-118 (FIG. 10A) of output file 115 specify a conditional logic statement: “(RSTHStudyInfo_ConsentObtained=‘True’ or RSTHStudyInfo_ConsentObtained=‘1’) and ($no-data-valued !=‘True’ or $incomplete=‘true’)“>”. The conditional logic statement 116-118 results from applying the conditional logic statement 111 (FIG. 8A) in the definition of phrase 99 to the first XSL processor 18. The data represented by the file 115 is then applied as an input to the second transformation processor 19, as described in more detail below.

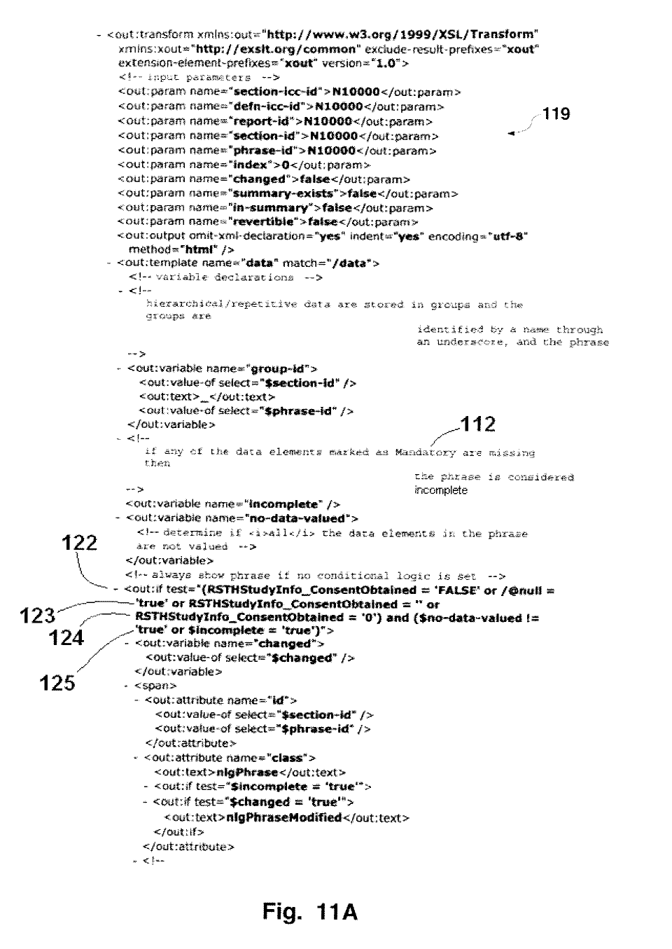

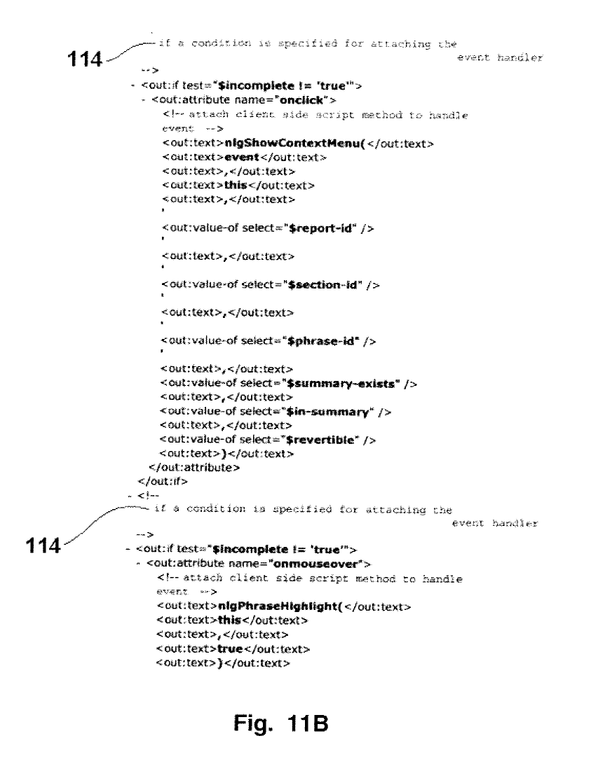

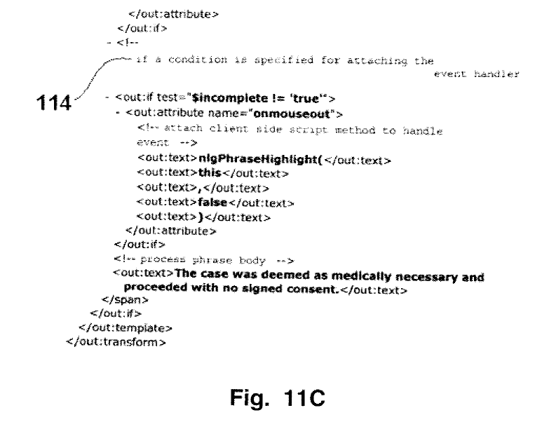

FIG. 11A, 11B and 11C illustrate an output file 119 (FIG. 11A) associated with the transformation of the third phrase 100. Referring to FIG. 8B, the first transformation processor 18 produces data in an XSL file 119 (FIG. 11A) associated with the conditional logic 121 of the show phrase segment 120, which specifies that the text 106 be shown in the editable document 15 when the condition 121 is satisfied. The XSL file 119 associates other phrase rendering logic such as mandatory data 112 (FIG. 11A) and the attachment of customizable event handlers 114 (FIGS. 11B and 11C) according to the definition of phrase 100. For example, the lines 122-125 of output file 119 (FIG. 11A) show that the conditional logic statement: “(RSTHStudyInfo_ConsentObtained=‘False’ or /@null=‘true’ or RSTHStudyInfo_ConsentObtained=” or RSTHStudyInfo_ConsentObtained=‘0’) and ($no-data-valued !=‘true’ or $incomplete=‘true’)“>” This conditional logic statement is the result of applying the conditional logic 121 in the definition of phrase 100 (FIG. 8B) performed by the first XSL processor 18. The data represented by the XSL file 119 is then applied as the input to the second transformation processor 19.

Referring again to FIG. 1, the second transformation processor 19 processes the received clinical data items 13 and the formatted individual phrases in XSL form from the first transformation processor 18 to incorporate the data 13 into the corresponding formatted individual phrases, such as phrases 98, 99 and 100 (FIG. 8). The second transformation processor 19 evaluates the data items 13 to determine how to render the phrase, including, for example, phrase conditional logic statement evaluation, mandatory/non-mandatory data processing and launching of the visual indicator application for edited phrases or phrases that lack mandatory data values.

The second transformation processor 19 uses the corresponding individual conditional logic statements and the values of data items 13 to determine whether an individual phrase is included for presentation in the formatted report text in the editable document 15. That is, the second transformation processor 19 processes an individual conditional logic statement using a received data item to determine that a received data item satisfies a condition represented by the conditional logic statement. The second transformation processor 19 then initiates incorporation of the received valid data item in the individual phrase and incorporation of the individual phrase in the formatted report text.

More specifically, in the illustrated embodiment, the second transformation processor 19 processes the received clinical data items 13 and the formatted individual phrases using an XSL compatible process. The second transformation processor 19 may determine whether inclusion of a phrase element is mandatory within an individual phrase in the formatted report, and evaluate a corresponding conditional logic statement to determine if a received data item is to be incorporated in the individual phrase indicated for mandatory inclusion.

Further, the second transformation processor 19 may determine whether an individual phrase is associated with repetitive data items and processes received data items and the formatted individual phrases to incorporate the data items in a list without repeating the individual phrase for each such received data item. If repetitive data is present, processor 19 processes the received data items 13 and the formatted individual phrases 98, 99 and 100, for example, to incorporate the repetitive data items in an NLG list via the NLG list engine 56 without repeating the individual phrase for each received data item. The processor 19 also initiates generation of an alert message for display to a user 14 if the evaluation of the corresponding conditional logic statement 121 (FIG. 8B), for example, determines that a received data item 13 is not to be incorporated in a particular individual phrase 100, for example.

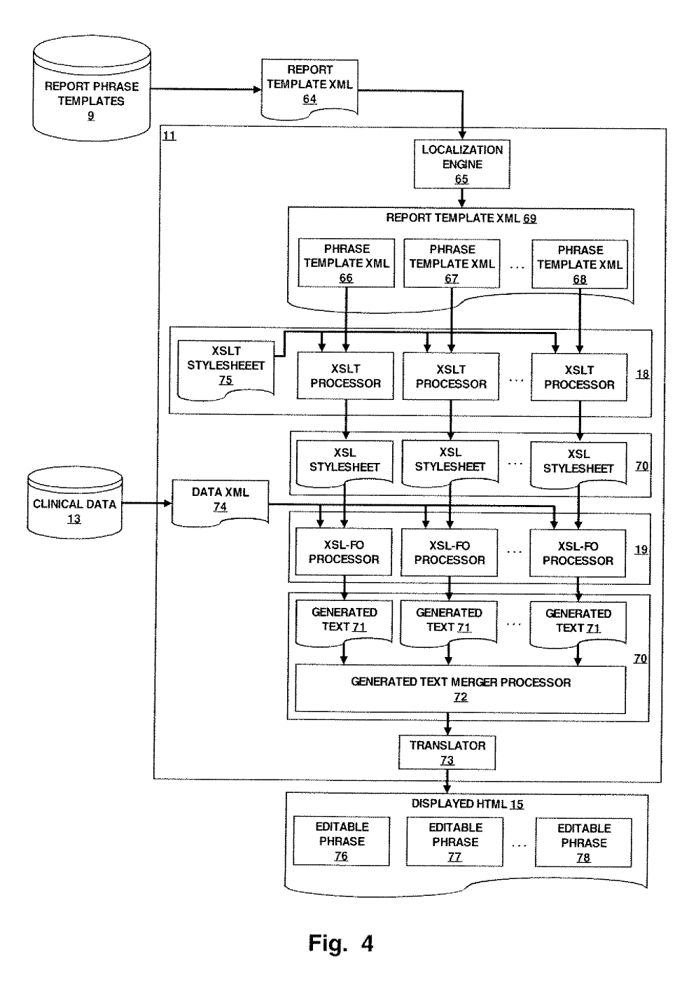

The second transformation processor 19 is either an XSL or XSL formatting objects (XSL-FO) processor that combines the clinical data 13 in an XML format spreadsheet 74 (FIGS. 4, 5 and 6) with the intermediate XSL stylesheet 70 (FIG. 6) produced by the first transformation processor 18. The second transformation processor 19 determines whether to attach event handlers 114 to a phrase and to render the phrase as a web browser editable DHTML document 15. When the second processor 19 is an XSL-FO processor, the processor 19 serves the function of output formatting engine 17 (FIG. 1) and automatically adaptively outputs data in a selected format such as PDF, RTF, LaTeX or SVG.

Referring to FIG. 4, in any event the output of the second transformation processor 19 is text 71 (FIG. 4) which is produced in the desired output document format. After all of the individual phrases are generated, the phrases are merged by merge processor 72 into a document 15 viewable to the user 14. In a preferred embodiment the user viewable generated output 15 is a DHTML document, which allows for user editing and modification of the generated phrases. In an alternate embodiment the merged text created by merge processor 72 may be internationalized by further processing using a translator 73, adapted to generate an editable formatted report text in one of a plurality of natural languages, prior to creating the displayed document 15. In either embodiment, the displayed document 15 contains a plurality of editable phrases such as phrases 76, 77 and 78, for example. After the collection of generated phrases 76, 77 and 78 is created by the report generator 11 and displayed as document 15, the user 14 can invoke the edit workflow as depicted in FIG. 5.

Referring to FIG. 5, the editing process is typically initiated via a customizable event such as double clicking a pointing device on a particular generated phrase 76. Using the phrase edit engine 16, the user 14 is able to modify the phrase text, data element values or both, and the edited values are transferred into the database 13 (FIG. 1). The modified values and text are then reentered into the localized XML report phrase template 64 and the updated data values are forwarded to the first transformation processor 18 and the second transformation processor 19. The second transformation processor 19 generates the revised phrase text 79 (FIGS. 5 and 6), creating revised editable phrases 80, 81 and 82 for display as revised document 83. During the phrase revision process the report generator 11 reevaluates the conditional logic statements using the updated data values. In a preferred embodiment a visual indicator is used to indicate the presence of an edited phrase in revised document 83.

Referring to FIG. 6, when the user 14 has completed editing the revised document 79, the user can forward the document to an ultimate destination 4, 5, 84 or 85 with a specified output file format. The XSL-FO transformation processor 19 can create a document 79 in multiple document formats without making changes to the processor inputs. Formats, such as PDF and PS can be displayed on a screen 84 for print previewing. One preferred document file format is the LaTeX format, which is typically smaller in size than comparable PDF and PS files. Generating the document in the LaTeX format allows faster transmission to mobile devices over low bandwidth connections such as Bluetooth, SMS and IrDA.

While the foregoing preferred embodiment of the invention has been described in detail, no material limitations to the scope of the invention are intended. Various alternative embodiments may be readily envisioned, including the use of context free grammars, knowledge bases, and mail merge templates. The report generator 11 is not limited to being used in association with clinical data 13. Data from any domain can be used as long as the data is presented to the report generator 11 in the expected XML format. As only one of many potential uses of the present invention, the system 1 is usable for the generation of medical reports, letters, instructions, notes, and for the generation of on screen instructions in other applications.

What is claimed is:

1. A report generation system, comprising:
a first transformation processor for processing individual coded template text representative phrases for accommodating corresponding data items to provide corresponding formatted individual phrases, said individual coded template text representative phrases being associated with corresponding individual conditional logic statements; and
a second transformation processor for processing received data items and said formatted individual phrases to incorporate said data items in corresponding formatted individual phrases to provide formatted report text and for using said corresponding individual conditional logic statements to determine whether an individual phrase is included in said formatted report text.

2. The system according to claim 1, wherein:
said individual coded template text representative phrases include placeholders for accommodating said corresponding data; and
said second transformation processor processes said received data items and said formatted individual phrases to incorporate said data items in said placeholders.

3. The system according to claim 1, wherein said individual coded template text representative phrases include XML coded template text.

4. The system according to claim 1, wherein said first transformation processor provides said corresponding formatted individual phrases as XSL compatible data.

5. The system according to claim 1, wherein said second transformation processor processes said received data items and said formatted individual phrases using an XSL compatible process.

6. The system according to claim 1, wherein said second transformation processor processes said received data items and said formatted individual phrases to incorporate said data items in corresponding formatted individual phrases to provide formatted report text in an adaptively selectable output format.

7. The system according to claim 6, wherein said adaptively selectable output format comprises at least one of: (a) DHTML, (b) HTML, (c) PDF, (d) RTF, (e) Word, (f) LaTeX, and (g) SVG compatible format.

8. The system according to claim 1, wherein said second transformation processor processes an individual conditional logic statement using a received data item to determine that a received data item satisfies a condition represented by said conditional logic statement and initiates incorporation of said received valid data item in said individual phrase and incorporation of said individual phrase in said formatted report text.

9. The system according to claim 1, wherein said second transformation processor determines whether inclusion of a phrase element is mandatory within an individual phrase in said formatted report text and evaluates a corresponding conditional logic statement to determine if a received data item is to be incorporated in said individual phrase indicated for mandatory inclusion.

10. The system according to claim 9, wherein said second transformation processor initiates generation of an alert message for display to a user if said evaluation of said corresponding conditional logic statement determines a received data item is not to be incorporated in said individual phrase.

11. The system according to claim 1, wherein said received data items are clinical data items concerning a particular patient and said formatted report text comprises text for inclusion in a medical report concerning said particular patient.

12. The system according to claim 1, wherein said second transformation processor determines whether an individual phrase is associated with repetitive data items and processes received data items and said formatted individual phrases to incorporate said data items in a list without repeating said individual phrase for each received data item.

13. A report generation system, comprising:
a first transformation processor for processing individual coded template text representative phrases for accommodating corresponding data items to provide corresponding formatted individual phrases, said individual coded template text representative phrases being associated with corresponding individual conditional logic statements; and
a second transformation processor for processing received data items and said formatted individual phrases to incorporate said data items in corresponding formatted individual phrases to provide formatted report text by:
processing an individual conditional logic statement using a received data item to determine a received data item satisfies a condition represented by said conditional logic statement, and
initiating incorporation of said received valid data item in said individual phrase and incorporation of said individual phrase in said formatted report text.

14. The report generation system of claim 13, further comprising a source of data items adapted to be inserted into predetermined locations within the individual coded template text representative phrases.

15. The report generation system of claim 14, further comprising:
a first computer readable language used for coding individual template text representative phrases; and
a second computer readable language for formatting individual phrases to create the formatted report text.

16. The report generation system of claim 15, wherein the first transformation processor creates an output data stream constructed in the second computer readable language.

17. The report generation system of claim 16, further comprising a translator adapted to generate an editable formatted report text in one of a plurality of natural languages.

18. A method of generating a formatted natural language medical report from clinical data, comprising the steps of:
creating a template of natural language phrases that are likely to appear in the medical report;
processing the clinical data so as to insert selected data into predetermined locations within the template;
conducting an evaluation of the presence and absence of clinical data in each of the predetermined locations within the template; and
formatting a natural language medical report in response to the evaluation of data populating the predetermined locations within the template.

19. The method of claim 18, further comprising the step of displaying editable individual phrases, derived from the template and the evaluation of the presence and absence of clinical data, via a graphical user interface accessible to a user of the clinical data so as to permit editing of the individual phrases.

20. The method of claim 19, further comprising the steps of:
alerting the user as to the absence of required data within the editable individual phrases; and
alerting the user to the absence of an editable individual phrase from displayed editable individual phrases whenever an absent phrase has been associated with an existing clinical data value.
